(19) United States
(12) Patent Application Publication
(10) Pub. No.: US 2026/0081543 A1
(43) Pub. Date: Mar. 19, 2026

(54) MOTOR DRIVER FOR PERFORMING PROGRESSIVE DRIVING MECHANISM

(71) Applicant: ANPEC ELECTRONICS CORPORATION, HSINCHU (TW)

(72) Inventor: MING-JUNG TSAI, CHANGHUA COUNTY (TW)

(21) Appl. No.: 18/947,287

(22) Filed: Nov. 14, 2024

(30) Foreign Application Priority Data
Sep. 13, 2024 (TW) 113134748

(51) Int. Cl. H02P 3/18; H02P 3/02

(52) U.S. Cl. CPC H02P 3/18; H02P 3/02; H02P 2205/07; H02P 2209/00

(57) ABSTRACT

A motor driver having a progressive driving mechanism is provided. The motor driver includes a progressive driving setting circuit, a progressive waveform constructing circuit and a motor driving circuit. The progressive driving setting circuit outputs a progressive driving setting signal that is progressively changed over time. The progressive driving setting signal has a plurality of progressive driving set voltages respectively at a plurality of set time points. The progressive driving set voltages are different from each other. The progressive waveform constructing circuit sets a plurality of waveforms of a progressive waveform signal according to the progressive driving set voltages. Duty cycles of the plurality of waveforms of the progressive waveform signal are different from each other. The motor driving circuit drives a motor according to the progressive waveform signal.

### CROSS-REFERENCE TO RELATED PATENT APPLICATION

This application claims the benefit of priority to Taiwan Patent Application No. 113134748, filed on Sep. 13, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor, and more particularly to a motor driver having a progressive driving mechanism.

### BACKGROUND OF THE DISCLOSURE

Circuit components of electronic devices produce heat during operation, by which air circulated throughout an enclosed space, especially in an enclosed chassis, is heated up. As a result, other circuit components in the enclosed space are damaged due to overheating. Therefore, a plurality of fans must be disposed in the electronic devices and used to cool down the circuit components of the electronic devices. When each of the circuit components of the electronic devices is cooled down to have a temperature being lower than a temperature threshold, rotational speed of motors of the fans is appropriately reduced.

The plurality of fans are often arranged and installed in the electronic device such as a server, and used to cool down processors and other heat-generating components in the electronic device. When the plurality of fans rotate, heated air is blown out of the electronic device along a forward direction, thereby reducing the temperature inside the electronic device. However, when any one of the plurality of fans is damaged and removed from the electronic device, air flows into an accommodation space in which the one of the plurality of fans was previously installed along a backward direction. As a result, a new fan that is then installed into the accommodation space to replace the damaged fan rotates at a high rotational speed along the backward direction. Under this condition, conventional motor drivers cannot effectively brake the motors of the fans. Therefore, an effective braking method must be developed for preventing the new fan from rotating along the backward direction.

In order to brake the motors of the fans, in the conventional motor drivers, a plurality of high-side switches are directly switched from an off-state to an on-state, and a plurality of low-side switches are directly switched from the on-state to the off-state. When the high-side switches of the conventional motor drivers are in the on-state for a short period of time, the conventional motor drivers only apply small braking force on the motors such that the rotational speed of the motors of the fans are unable to be reduced to a zero value. When the high-side switches of the conventional motor drivers are in the on-state for a long period of time, excessive braking currents flow through the motors of the fans such that the motors are damaged due to overcurrent. For example, when an intensity of the return air flowing around the motors is a low value, the motors have small back electromotive force. At this time, if the high-side switches of the conventional motor drivers are in the on-state for a long period of time, the excessive braking currents flow through the motors. Conversely, when the intensity of the return air flowing around the motors is a high value and the high-side switches of the conventional motor drivers are in the on-state for a short period of time, the rotational speed of the motors are unable to be reduced to the zero value for successfully braking the motors.

### SUMMARY OF THE DISCLOSURE

In response to the above-referenced technical inadequacies, the present disclosure provides a motor driver having a progressive driving mechanism. The motor driver includes a progressive driving setting circuit, a progressive waveform constructing circuit and a motor driving circuit. The progressive driving setting circuit is configured to output a progressive driving setting signal that is progressively changed over time. The progressive driving setting circuit is configured to set the progressive driving setting signal to have a plurality of progressive driving set voltages respectively at a plurality of set time points. The progressive driving set voltages are different from each other. The progressive waveform constructing circuit is connected to the progressive driving setting circuit. The progressive waveform constructing circuit is configured to set a plurality of waveforms of a progressive waveform signal according to the plurality of progressive driving set voltages. Duty cycles of the plurality of waveforms of the progressive waveform signal are different from each other. The motor driving circuit is connected to the progressive waveform constructing circuit and a motor. The motor driving circuit is configured to output a progressive driving signal to the motor according to the progressive waveform signal.

As described above, the present disclosure provides the motor driver having the progressive driving mechanism. The motor driver of the present disclosure performs the progressive driving mechanism on the motor to apply progressive braking force to the motor for appropriately controlling a current flowing through the motor. In particular, when the motor driver of the present disclosure brakes the motor, the motor driver of the present disclosure appropriately controls a braking current flowing through the motor to prevent the motor from being damaged due to overcurrent. For example, when intensity of return air flowing around the motors is the high value, the motor driver of the present disclosure outputs a large braking current to the motor for braking the motor. Conversely, when the intensity of the return air flowing around the motors is a low value, the motor driver of the present disclosure supplies the reduced braking current to the motor to apply the reduced braking force on the motor such that the motor is prevented from being damaged due to overcurrent while braking.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a motor driver having a progressive driving mechanism according to a first embodiment of the present disclosure;

FIG. 2 is a block diagram of a motor driver having a progressive driving mechanism according to a second embodiment of the present disclosure;

FIG. 3 is a block diagram of a motor driver having a progressive driving mechanism according to a third embodiment of the present disclosure;

FIG. 4 is a circuit diagram of a comparator included in a progressive waveform constructing circuit of a motor driver having a progressive driving mechanism according to a fourth embodiment of the present disclosure;

FIG. 5 is a waveform diagram of signals of the motor driver according to a fifth embodiment of the present disclosure;

FIG. 6 is a schematic diagram of a curve of duty cycles of a plurality of waveforms of a progressive waveform signal generated by the motor driver versus time according to a sixth embodiment of the present disclosure;

FIG. 7 is a schematic diagram of a plurality of curves of duty cycles of waveforms of a plurality of progressive waveform signals generated by the motor driver versus time according to a seventh embodiment of the present disclosure;

FIG. 8 is a schematic diagram of a curve of rotational speed of a motor detected by the motor driver versus time according to an eighth embodiment of the present disclosure;

FIG. 9 is a waveform diagram of signals of the motor driver according to a ninth embodiment of the present disclosure; and

FIG. 10 is a waveform diagram of signals of the motor driver according to a tenth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

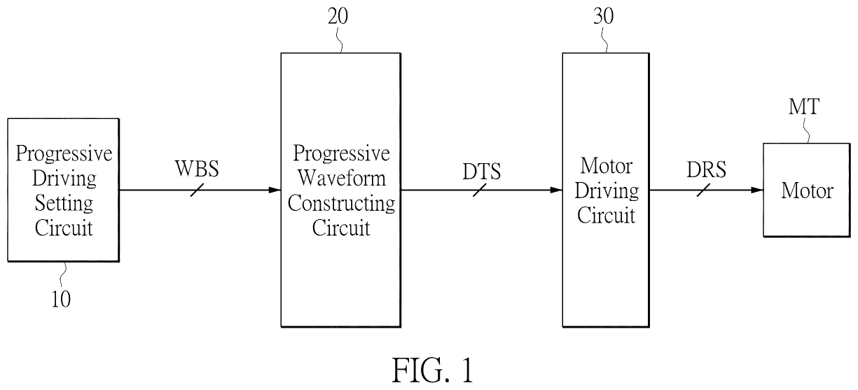

Reference is made to FIG. 1, which is a block diagram of a motor driver having a progressive driving mechanism according to a first embodiment of the present disclosure.

As shown in FIG. 1, in the first embodiment, the motor driver of the present disclosure includes a progressive driving setting circuit 10, a progressive waveform constructing circuit 20 and a motor driving circuit 30. The progressive waveform constructing circuit 20 is connected to the progressive driving setting circuit 10 and the motor driving circuit 30. The motor driving circuit 30 is connected to a motor MT. The motor MT described herein may be a motor of a fan or other electronic device, and may be a three-phase motor or a single-phase motor.

The progressive driving setting circuit 10 sets a progressive driving setting signal WBS to have a plurality of progressive driving set voltages respectively at a plurality of set time points, and outputs the progressive driving setting signal WBS. It is worth noting that, the progressive driving setting signal WBS is progressively changed over time. For example, the progressive driving setting signal WBS is progressively increased or decreased over time.

Then, the progressive waveform constructing circuit 20 sets duty cycles of a plurality of waveforms of a progressive waveform signal DTS according to the plurality of progressive driving set voltages of the progressive driving setting signal WBS from the progressive driving setting circuit 10. The later the waveform is generated among the plurality of waveforms of the progressive waveform signal DTS, the larger or smaller the duty cycle of the waveform is. That is, the progressive waveform constructing circuit 20 constructs the progressive waveform signal DTS having duty cycle that is progressively changed over time.

Finally, the motor driving circuit 30, according to the progressive waveform signal DTS from the progressive waveform constructing circuit 20, sets and outputs one or more progressive driving signals DRS to the motor MT for progressively driving the motor MT while a current flowing through the motor MT is smaller than a current threshold. In particular, when the motor driving circuit 30 brakes the motor MT, the motor driving circuit 30 progressively increases or reduces braking speed of the motor MT while a reverse current (including a braking current) flowing through the motor MT is smaller than the current threshold.

For example, the later the waveform is generated among the plurality of waveforms of the progressive waveform signal DTS, the larger the duty cycle of the waveform is, and the higher the braking speed of the motor MT is. Alternatively, the later the waveform is generated among the plurality of waveforms of the progressive waveform signal DTS, the smaller the duty cycle of the waveform is, and the lower the braking speed of the motor MT is.

That is, the motor driver of the present disclosure progressively changes the duty cycles of the plurality of waveforms of the progressive waveform signal DTS outputted to the motor MT for progressively driving the motor MT such that rotational speed of the motor MT is progressively changed over time. In particular, the motor driving circuit 30 of the motor driver of the present disclosure progressively changes, for example, increases or decreases the braking speed of the motor MT over time, thereby preventing the motor MT from being damaged due to overcurrent.

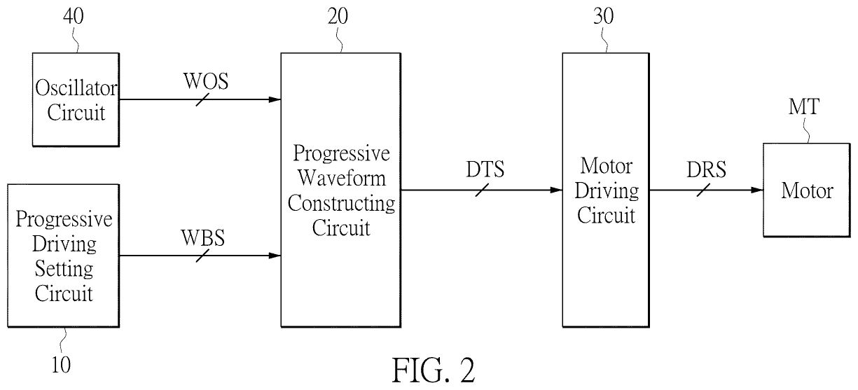

Reference is made to FIG. 2, which is a block diagram of a motor driver having a progressive driving mechanism according to a second embodiment of the present disclosure. The descriptions of the second embodiment that are the same as the descriptions of the first embodiment are not repeated herein.

A difference between the second and first embodiments of the present disclosure is that, the motor driver of the second embodiment of the present disclosure further includes an oscillator circuit 40.

The oscillator circuit 40 is connected to the progressive waveform constructing circuit 20. The oscillator circuit 40 may include an oscillator. The oscillator circuit 40 may output an oscillation waveform signal WOS.

The progressive waveform constructing circuit 20 uses a plurality of waveforms of the oscillation waveform signal WOS as a plurality of oscillation waveforms, and uses a plurality of voltages on the plurality of oscillation waveforms of the oscillation waveform signal WOS as a plurality of oscillation voltages.

On the other hand, the progressive driving setting circuit 10 outputs the progressive driving setting signal WBS according to the plurality of progressive driving set voltages respectively at the plurality of set time points.

The progressive waveform constructing circuit 20 compares the plurality of progressive driving set voltages of the progressive driving setting signal WBS that are set at the plurality of set time points respectively with the plurality of oscillation voltages on the plurality of oscillation waveforms of the oscillation waveform signal WOS to set the duty cycles of the plurality of waveforms of the progressive waveform signal DTS.

For example, the plurality of oscillation waveforms of the oscillation waveform signal WOS includes a plurality of triangular waves, a plurality of sawtooth waveforms or a combination thereof, but the present disclosure is not limited thereto.

The motor driving circuit 30 sets one or more progressive driving signals DRS according to the duty cycles of the plurality of waveforms of the progressive waveform signal DTS from the progressive waveform constructing circuit 20, and outputs the one or more progressive driving signals DRS to the motor MT for progressively driving the motor MT.

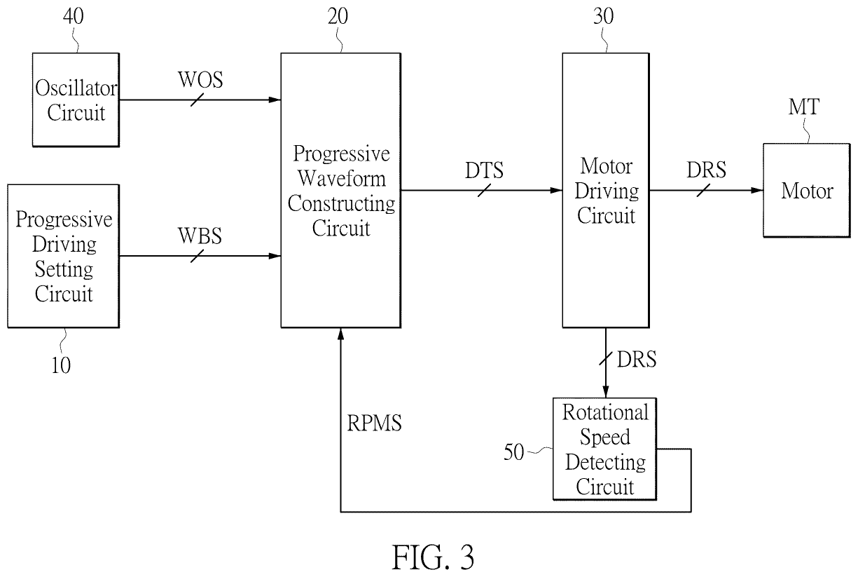

Reference is made to FIG. 3, which is a block diagram of a motor driver having a progressive driving mechanism according to a third embodiment of the present disclosure. The descriptions of the third embodiment that are the same as the descriptions of the first and second embodiment are not repeated herein.

A difference between the third and second embodiments is that, the motor driver of the third embodiment of the present disclosure further includes a rotational speed detecting circuit 50. The rotational speed detecting circuit 50 is connected to the progressive waveform constructing circuit 20.

Each of circuits of the motor driver of the present disclosure such as the progressive driving setting circuit 10, the progressive waveform constructing circuit 20, the motor driving circuit 30, the oscillator circuit 40 and the rotational speed detecting circuit 50 may include one or more circuit components. Types and configurations of the circuit components may depend on actual requirements, and the present disclosure is not limited thereto.

The rotational speed detecting circuit 50 detects the progressive driving signal DRS that is outputted to the motor MT by the motor driving circuit 30, and then estimates the rotational speed of the motor MT according to the progressive driving signal DRS being detected to output a motor rotational speed detected signal RPMS.

The progressive waveform constructing circuit 20, according to the motor rotational speed detected signal RPMS from the rotational speed detecting circuit 50, modulates and outputs the duty cycles of the plurality of waveforms of the progressive waveform signal DTS.

When the rotational speed of the motor MT detected by the rotational speed detecting circuit 50 is not lower than a rotational speed threshold (such as a zero value), the progressive waveform constructing circuit 20 may continually increase the duty cycles of the progressive waveform signal DTS. As a result, braking force that is applied on the motor MT by the motor driving circuit 30 is increased.

Conversely, when the rotational speed of the motor MT detected by the rotational speed detecting circuit 50 is lower than the rotational speed threshold (such as the zero value), the progressive waveform constructing circuit 20 may stop increasing progressively and maintain the duty cycles of the progressive waveform signal DTS outputted to the motor driving circuit 30 such that braking force that is applied on the motor MT by the motor driving circuit 30 is not further increased. Alternatively, the progressive waveform constructing circuit 20 may stop outputting the progressive waveform signal DTS to the motor driving circuit 30 such that the motor driving circuit 30 stops braking the motor MT. As a result, when the rotational speed of the motor MT reaches a target rotational speed or a difference between the rotational speed of the motor MT and the target rotational speed is smaller than a rotational speed difference threshold, the motor driving circuit 30 stops braking the motor MT or reduces the braking force applied on the motor MT rather than continually increasing the braking force and the braking current of the motor MT.

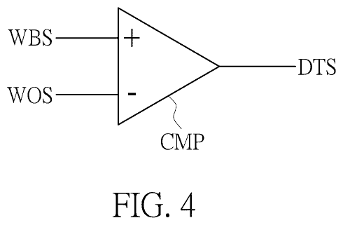

Reference is made to FIG. 4, which is a circuit diagram of a comparator included in a progressive waveform constructing circuit of a motor driver having a progressive driving mechanism according to a fourth embodiment of the present disclosure.

The progressive waveform constructing circuit 20 shown in FIG. 2 or FIG. 3 may include a comparator circuit. The comparator circuit may include a comparator CMP shown in FIG. 4.

A first input terminal such as a non-inverting input terminal of the comparator CMP shown in FIG. 4 is connected to the progressive driving setting circuit 10 shown in FIG. 2 or FIG. 3, and receives the progressive driving setting signal WBS from the progressive driving setting circuit 10 shown in FIG. 2 or FIG. 3.

A second input terminal such as an inverting input terminal of the comparator CMP shown in FIG. 4 is connected to the oscillator circuit 40 shown in FIG. 2 or FIG. 3, and receives the oscillation waveform signal WOS from the oscillator circuit 40 shown in FIG. 2 or FIG. 3.

The comparator CMP shown in FIG. 4 compares the progressive driving set voltage of the progressive driving setting signal WBS that is set at each of the plurality of set time points with the oscillation voltage of the oscillation waveform signal WOS to set logic levels of the progressive waveform signal DTS. The comparator CMP shown in FIG. 4 outputs the progressive waveform signal DTS to the motor driving circuit 30 shown in FIG. 2 or FIG. 3.

The motor driving circuit 30 shown in FIG. 2 or FIG. 3, according to the progressive waveform signal DTS from the comparator CMP shown in FIG. 4, sets the progressive driving signal DRS shown in FIG. 2 or FIG. 3 and outputs the progressive driving signal DRS to the motor MT for progressively driving the motor MT. For example, the motor driving circuit 30 progressively brakes the motor MT.

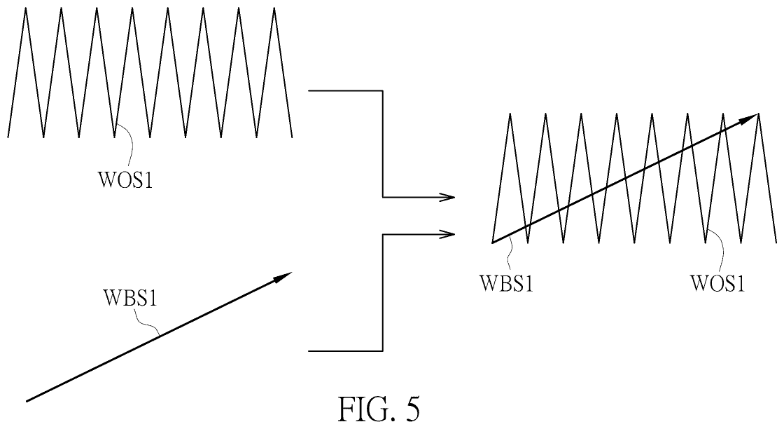

Reference is made to FIG. 5, which is a waveform diagram of signals of the motor driver according to a fifth embodiment of the present disclosure.

The oscillation waveform signal WOS outputted by the oscillator circuit 40 shown in FIG. 2 or FIG. 3 may be the same as an oscillation waveform signal WOS1 shown in FIG. 5. The oscillation waveform signal WOS1 includes a plurality of triangular waveforms.

The progressive driving setting signal WBS that is outputted according to the plurality of progressive driving set voltages at the plurality of set time points by the progressive driving setting circuit 10 shown in FIG. 2 or FIG. 3 may be the same as a progressive driving setting signal WBS1 shown in FIG. 5. The progressive driving setting signal WBS1 includes a progressive driving setting pattern such as, but not limited to, an arrow pattern, a line pattern or a curved pattern.

In detail, after the plurality of progressive driving voltages are set at the plurality of set time points, the progressive driving setting circuit 10 may connect the progressive driving set voltage at each one of the plurality of set times to the progressive driving set voltage at a next one of the plurality of set times through a progressive driving setting pattern segment on the progressive driving setting signal WBS1 (in a curve graph). In this process, a plurality of voltages on the progressive driving setting signal WBS1 at a plurality of unset times are set. The progressive driving setting circuit 10 may connect the plurality of progressive driving setting pattern segments of the progressive driving setting signal WBS1 between the plurality of set times with each other to form the progressive driving setting pattern. As shown in FIG. 5, the progressive driving setting pattern of the progressive driving setting signal WBS1 is a linear arrow line, but the present disclosure is not limited thereto.

The progressive driving setting circuit 10 may set a slope of the progressive driving setting pattern according to a piece of driving demand information (such as, but not limited to, a piece of braking speed demand information including amount, intensity and flowing speed of return air around the motor MT).

In addition or alternatively, the progressive driving setting circuit 10 may set a plurality of slopes of a plurality of stepped waveform segments according to a plurality of pieces of driving demand information (such as, but not limited to, a plurality of pieces of braking speed demand information each including the amount, the intensity and the flowing speed of the return air around the motor MT) within a plurality of time intervals, respectively.

The higher the braking speed instructed by the braking speed demand information is, the larger the slope of the progressive driving setting pattern that is set by the progressive driving setting circuit 10 is. The lower the braking speed instructed by the braking speed demand information is, the smaller the slope of the progressive driving setting pattern that is set by the progressive driving setting circuit 10 is.

The progressive driving setting circuit 10 outputs the progressive driving setting signal WBS1 according to the progressive driving setting pattern.

The progressive waveform constructing circuit 20 may compare the plurality of progressive driving set voltages on the progressive driving setting pattern of the progressive driving setting signal WBS1 at the plurality of set time points respectively with a plurality of oscillation voltages of a plurality of oscillation waveforms of the oscillation waveform signal WOS1 as shown in FIG. 5, and accordingly set the duty cycles of the plurality of waveforms of the progressive waveform signal DTS shown in FIG. 2 and FIG. 3.

In addition or alternatively, the progressive waveform constructing circuit 20 may compare the plurality of voltages on the progressive driving setting pattern of the progressive driving setting signal WBS1 at the plurality of unset times respectively with a plurality of oscillation voltages on the plurality of oscillation waveforms of the oscillation waveform signal WOS1 as shown in FIG. 5, and accordingly set the duty cycles of the plurality of waveforms of the progressive waveform signal DTS shown in FIG. 2 and FIG. 3.

As shown in FIG. 2 and FIG. 3, the motor driving circuit 30 may output the progressive driving signal DRS to the motor MT according to the progressive waveform signal DTS from the progressive waveform constructing circuit 20 for progressively driving the motor MT. For example, the motor driving circuit 30 may progressively change the braking speed of the motor MT.

For example, when the intensity of the return air around the motor MT is a low value, the motor driving circuit 30 controls a braking current IBKS flowing through the motor MT to be smaller than a first reverse current threshold, thereby preventing the motor MT from being damaged due to overcurrent.

Conversely, when the intensity of the return air around the motor MT is a high value, the motor driving circuit 30 controls the braking current IBKS of the motor MT to be larger than the first reverse current threshold and smaller than a second reverse current threshold for reducing the rotational speed of the motor MT to a zero value, thereby preventing an overcurrent event from occurring.

That is, in the fifth embodiment of the present disclosure, the progressive driving setting circuit 10 appropriately sets the slope of the progressive driving setting pattern, the plurality of slopes of the plurality of stepped waveform segments or a combination thereof for preventing the motor MT that is driven or braked by the motor driving circuit 30 from being damaged due to overcurrent.

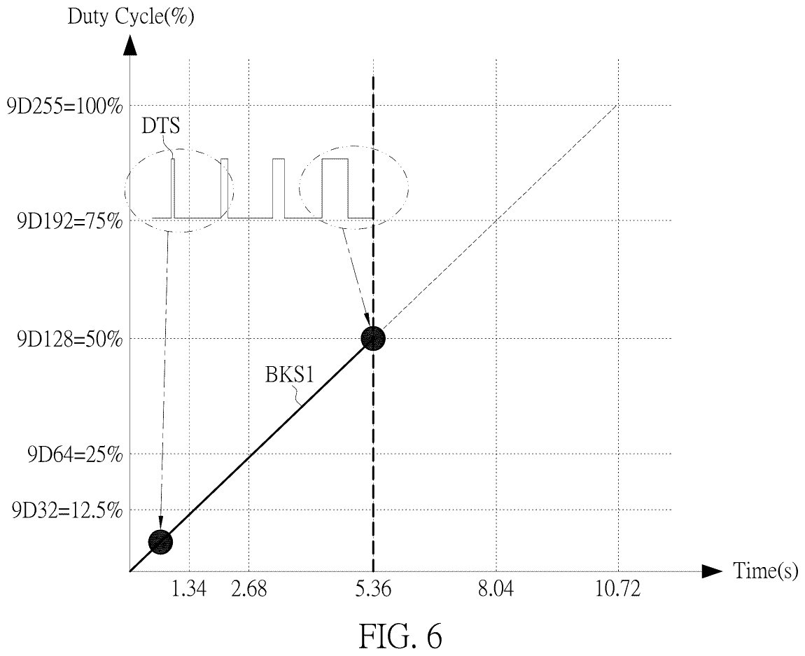

Reference is made to FIG. 6, which is a schematic diagram of a curve of duty cycles of a plurality of waveforms of a progressive waveform signal generated by the motor driver versus time according to a sixth embodiment of the present disclosure.

The progressive waveform constructing circuit 20 shown in FIG. 1 to FIG. 3 may modulate the progressive waveform signal DTS over time. As shown in FIG. 6, the progressive waveform signal DTS has a plurality of waveforms, and the duty cycle of the progressive waveform signal DTS is increased over time for increasing the braking force applied on the motor MT over time.

A duty cycle variation curve BKS1 shown in FIG. 6 is a curve of the duty cycles of the progressive waveform signal DTS versus time. For example, the duty cycle of the progressive waveform signal DTS is linearly increased from 12.5% corresponding to a code 9D32 to 100% corresponding to a code 9D255 over time, but the present disclosure is not limited thereto.

The rotational speed detecting circuit 50 shown in FIG. 3 may detect the progressive waveform signal DTS that is outputted to the motor MT by the motor driving circuit 30 at time points at which the progressive waveform signal DTS shown in FIG. 6 reaches a high level. In addition or alternatively, the rotational speed detecting circuit 50 may detect the progressive waveform signal DTS at time points at which the progressive waveform signal DTS reaches a low level.

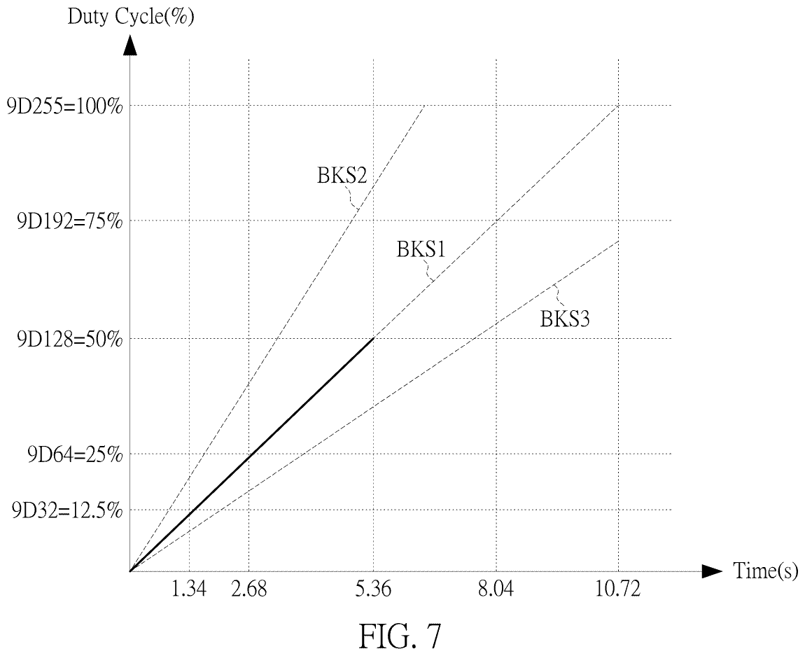

Reference is made to FIG. 7, which is a schematic diagram of a plurality of curves of duty cycles of waveforms of a plurality of progressive waveform signals generated by the motor driver versus time according to a seventh embodiment of the present disclosure.

The progressive waveform constructing circuit 20 shown in FIG. 1 to FIG. 3 may modulate a slope of a curve of the duty cycle of the progressive waveform signal DTS versus time. For example, the curve of the duty cycle of the progressive waveform signal DTS versus time may be the same as any one of a plurality of duty cycle variation curves BKS1, BKS2, BKS3. Slopes of the plurality of duty cycle variation curves BKS1, BKS2, BKS3 are different from each other.

That is, the slope of the curve of the duty cycle of the progressive waveform signal DTS versus time is a variable value. The progressive waveform constructing circuit 20 may set and modulate the slope of the curve of the duty cycle of the progressive waveform signal DTS versus time.

The motor driving circuit 30 may include a plurality of high-side switches and a plurality of low-side switches. Each of the plurality of high-side switches has a first terminal, a second terminal and a control terminal. Each of the plurality of low-side switches has a first terminal, a second terminal and a control terminal. A first terminal of each of the plurality of high-side switches is coupled with a common voltage. Second terminals of the plurality of high-side switches are respectively connected to first terminals of the plurality of low-side switches, and respectively connected to a plurality of terminals of the motor MT.

When the progressive waveform constructing circuit 20 outputs the progressive waveform signal DTS having a large slope to the motor driving circuit 30, a plurality of waveforms of an on-time signal of each or any one of the plurality of high-side switches included in the motor driving circuit 30 have large duty cycles. As a result, a large braking current flowing through the motor MT such that the motor MT is quickly braked.

In a conventional motor driver, a plurality of low-side switches are directly switched from an off-state to an on-state, and all of a plurality of high-side switches are directly switched from the on-state to the off-state for braking a motor.

Differently, in the motor driver of the present disclosure, the progressive waveform constructing circuit 20 outputs the progressive waveform signal DTS for progressively switching the plurality of low-side switches and the plurality of high-side switches from the on-state to the off-state or from the off-state to the on-state. As a result, the motor driving circuit 30 of the motor driver of the present disclosure applies the braking force that is progressively increased to the motor MT. Therefore, in comparison with the conventional motor driver, the motor driver of the present disclosure more effectively brakes the motor MT.

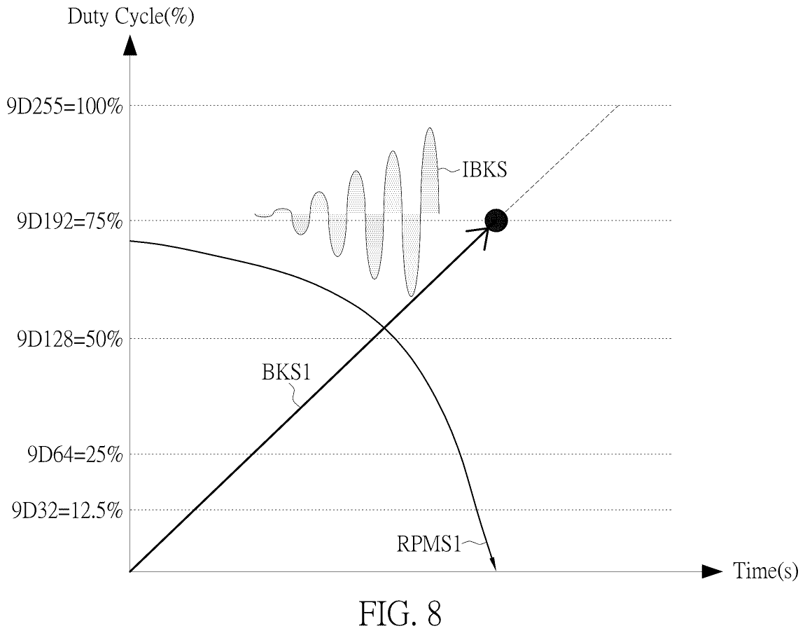

Reference is made to FIG. 8, which is a schematic diagram of a curve of rotational speed of a motor detected by the motor driver versus time according to an eighth embodiment of the present disclosure.

As shown in FIG. 3, the rotational speed detecting circuit 50 detects the progressive driving signal DRS that is outputted to the motor MT by the motor driving circuit 30, and then estimates the rotational speed of the motor MT to output the motor rotational speed detected signal RPMS according to the detected progressive driving signal DRS. The motor driving circuit 30 modulates the detected progressive driving signal DRS according to the motor rotational speed detected signal RPMS, and outputs the detected progressive driving signal DRS that is modulated to the motor MT.

The motor rotational speed detected signal RPMS shown in FIG. 3 may be the same as a motor rotational speed detected signal RPMS1 shown in FIG. 8. As shown in FIG. 8, as instructed by the motor rotational speed detected signal RPMS1, the rotational speed of the motor MT is reduced over time. At this time, the motor driver of the present disclosure brakes the motor MT such that the braking current IBKS shown in FIG. 8 flows through the motor MT.

The duty cycle of the cycle-time variation curve BKS1 is gradually increased such that the braking current IBKS flowing through the motor MT is gradually increased so as to increase the braking force applied on the motor MT over time. As shown in FIG. 8, a falling slope of a curve of the motor rotational speed detected signal RPMS1 is increased over time.

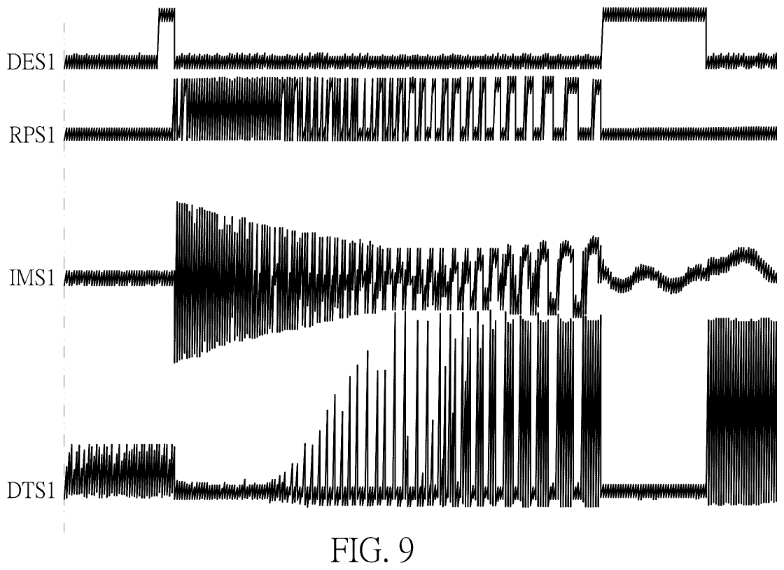

Reference is made to FIG. 9, which is a waveform diagram of signals of the motor driver according to a ninth embodiment of the present disclosure.

The rotational speed detecting circuit 50 shown in FIG. 3 may, within time during which a detection time instructing time DES1 shown in FIG. 9 reaches a high level, detect the progressive driving signal DRS that is outputted to the motor MT by the motor driving circuit 30, and estimate the rotational speed of the motor MT to output the motor rotational speed detected signal RPMS shown in FIG. 3 according to the progressive driving signal DRS being detected. The motor rotational speed detected signal RPMS shown in FIG. 3 may be the same as a motor rotational speed detected signal RPMS1 shown in FIG. 9.

The progressive waveform signal DTS outputted by the progressive waveform constructing circuit 20 shown in FIG. 3 may be the same as a progressive waveform signal DTS1 shown in FIG. 9.

The motor driving circuit 30 may, according to the motor rotational speed detected signal RPMS1 and the progressive waveform signal DTS1, set or modulate the progressive driving signal DRS such that a current signal IMS1 shown in FIG. 9 flows through the motor MT.

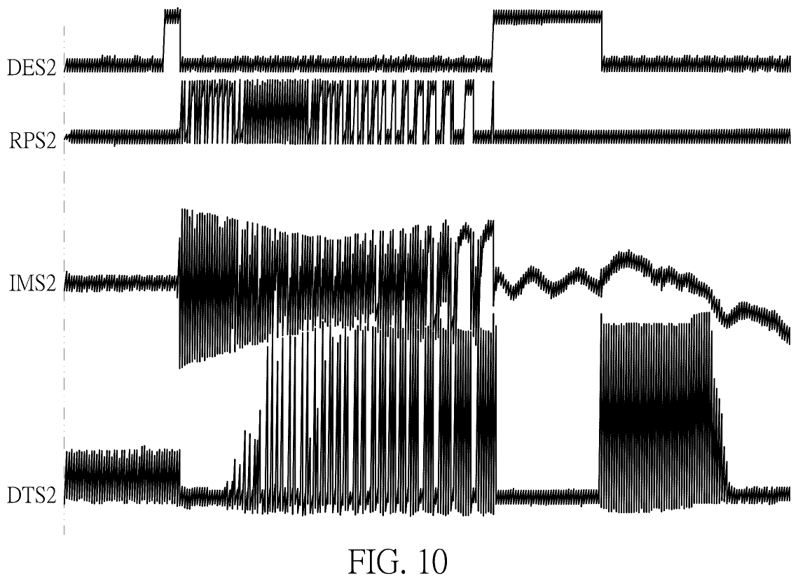

Reference is made to FIG. 10, which is a waveform diagram of signals of the motor driver according to a tenth embodiment of the present disclosure.

The rotational speed detecting circuit 50 shown in FIG. 3 may, within time during which a detection time instructing time DES2 shown in FIG. 10 reaches a high level, detect the progressive driving signal DRS that is outputted to the motor MT by the motor driving circuit 30 as shown in FIG. 3, and estimate the rotational speed of the motor MT to output the motor rotational speed detected signal RPMS shown in FIG. 3 according to the progressive driving signal DRS being detected. The motor rotational speed detected signal RPMS shown in FIG. 3 may be the same as a motor rotational speed detected signal RPMS2 shown in FIG. 10.

The progressive waveform signal DTS outputted by the progressive waveform constructing circuit 20 as shown in FIG. 3 may be the same as a progressive waveform signal DTS2 shown in FIG. 10.

The motor driving circuit 30 may, according to the motor rotational speed detected signal RPMS2 and the progressive waveform signal DTS2, set or modulate the progressive driving signal DRS such that a current signal IMS2 shown in FIG. 10 flows through the motor MT.

The progressive waveform signal DTS2 outputted by the rotational speed detecting circuit 50 is changed within a change in the slope of the progressive driving setting signal WBS outputted by the progressive driving setting circuit 10 shown in FIG. 3. Working periods of a plurality of waveforms of the progressive waveform signal DTS2 shown in FIG. 10 are different from working periods of a plurality of waveforms of the progressive waveform signal DTS1 shown in FIG. 9. As a result, the current signal IMS2 of the motor MT that is driven according to the progressive waveform signal DTS2 by the motor driving circuit 30 as shown in FIG. 10 is different from the current signal IMS1 of the motor MT that is driven according to the progressive waveform signal DTS1 by the motor driving circuit 30 as shown in FIG. 9.

That is, the motor driver of the present disclosure is capable of appropriately modulating the slope of the progressive driving setting signal WBS to control and modulate amounts and changing speed of the current (including the reverse current and the braking current) flowing through the motor MT per unit time, thereby preventing the motor MT from being damaged due to overcurrent.

In conclusion, the present disclosure provides the motor driver having the progressive driving mechanism. The motor driver of the present disclosure performs the progressive driving mechanism on the motor to apply the progressive braking force to the motor for appropriately controlling the current flowing through the motor. In particular, when the motor driver of the present disclosure brakes the motor, the motor driver of the present disclosure appropriately controls the braking current flowing through the motor to prevent the motor from being damaged due to overcurrent. For example, when the intensity of the return air flowing around the motors is the high value, the motor driver of the present disclosure outputs the large braking current to the motor for braking the motor. Conversely, when the intensity of the return air flowing around the motors is the low value, the motor driver of the present disclosure supplies the reduced braking current to the motor to apply the reduced braking force on the motor such that the motor is prevented from being damaged due to overcurrent while braking.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor driver having a progressive driving mechanism, comprising:
a progressive driving setting circuit configured to output a progressive driving setting signal that is progressively changed over time, configured to set the progressive driving setting signal to have a plurality of progressive driving set voltages respectively at a plurality of set time points, wherein the plurality of progressive driving set voltages are different from each other;
a progressive waveform constructing circuit connected to the progressive driving setting circuit, configured to set a plurality of waveforms of a progressive waveform signal according to the plurality of progressive driving set voltages, wherein duty cycles of the plurality of waveforms of the progressive waveform signal are different from each other; and
a motor driving circuit connected to the progressive waveform constructing circuit and a motor, and configured to output a progressive driving signal to the motor according to the progressive waveform signal.

2. The motor driver according to claim 1, wherein the motor driving circuit brakes the motor and gradually adjusts a braking speed of the motor over time.

3. The motor driver according to claim 1, wherein the progressive waveform constructing circuit includes a comparator circuit configured to compare the progressive driving set voltage at each of the plurality of set time points with an oscillation voltage to output the progressive waveform signal.

4. The motor driver according to claim 1, further comprising:
an oscillation circuit connected to the progressive waveform constructing circuit, and configured to output an oscillation waveform signal having a plurality of oscillation waveforms;
wherein the progressive waveform constructing circuit uses a plurality of voltages on the plurality of oscillation waveforms as a plurality of oscillation voltages, and compares the plurality of progressive driving set voltages respectively with the plurality of oscillation voltages to set the duty cycles of the plurality of waveforms of the progressive waveform signal.

5. The motor driver according to claim 4, wherein the plurality of oscillation waveforms of the oscillation waveform signal includes a plurality of triangular waves, a plurality of sawtooth waveforms, or a combination thereof.

6. The motor driver according to claim 1, wherein the progressive driving setting circuit connects the progressive driving set voltage at each one of the plurality of set time points to the progressive driving set voltage at a next one of the plurality of set time points through a progressive driving setting pattern segment, connects the plurality of progressive driving setting pattern segments between the plurality of set time points with each other to form a progressive driving setting pattern, and outputs the progressive driving setting signal according to the progressive driving setting pattern.

7. The motor driver according to claim 6, wherein the progressive waveform constructing circuit compares the plurality of progressive driving set voltages on the progressive driving setting patterns respectively with a plurality of oscillation voltages at the plurality of set times to set the duty cycles of the plurality of waveforms of the progressive waveform signal.

8. The motor driver according to claim 7, wherein the progressive waveform constructing circuit compares a plurality of voltages on the progressive driving setting pattern respectively with a plurality of oscillation voltages at a plurality of unset times to set the duty cycles of the plurality of waveforms of the progressive waveform signal.

9. The motor driver according to claim 6, wherein the progressive driving setting circuit sets a slope of the progressive driving setting pattern according to a piece of driving demand information.

10. The motor driver according to claim 6, wherein the progressive driving setting circuit sets slopes of the plurality of progressive driving setting pattern segments respectively according to a plurality of pieces of driving demand information that are respectively required within a plurality of time intervals.

11. The motor driver according to claim 1, wherein the progressive driving setting circuit constructs a stepped pattern waveform having a plurality of stepped waveform segments in the progressive driving setting signal, a height of each of the plurality of stepped waveform segments is the progressive driving set voltage, and a plurality of widths of the plurality of plurality of stepped waveform segments are a plurality of time lengths.

12. The motor driver according to claim 1, further comprising:
a rotational speed detecting circuit connected to the motor driving circuit, and configured to detect the progressive driving signal and estimate a rotational speed of the motor to output a motor rotational speed detected signal according to the progressive driving signal being detected.

13. The motor driver according to claim 12, wherein the motor driving circuit modulates the progressive driving signal according to the motor rotational speed detected signal and outputs the progressive driving signal that is modulated to the motor.

14. The motor driver according to claim 12, wherein, when the rotational speed of the motor is not lower than a rotational speed threshold, the motor driving circuit brakes the motor.

15. The motor driver according to claim 14, wherein, when the rotational speed of the motor is lower than the rotational speed threshold, the motor driving circuit stops braking the motor.

16. The motor driver according to claim 14, wherein the rotational speed threshold is a zero value.

17. The motor driver according to claim 1, wherein the motor is a three-phase motor or a single-phase motor.
